(19) United States
(12) Patent Application Publication
(10) Pub. No.: US 2025/0302228 A1
(43) Pub. Date: Oct. 2, 2025

(54) Brewer for a Coffee Machine

(71) Applicant: Bravilor Bonamat B.V., Heerhugowaard (NL)

(72) Inventor: Lorenzo Romanus Verhoeven, Heerhugowaard (NL)

(21) Appl. No.: 19/232,642

(22) Filed: Jun. 9, 2025

Related U.S. Application Data
(63) Continuation of application No. PCT/NL2024/050425, filed on Jul. 30, 2024.

(30) Foreign Application Priority Data
Aug. 9, 2023 (NL) 2035573

(51) Int. Cl. A47J 31/36; A47J 31/06

(52) U.S. Cl. CPC A47J 31/3614; A47J 31/0663; A47J 31/3619

(57) ABSTRACT

A brewer for a coffee machine. The brewer includes a brewing chamber and an inlet opening for receiving ground coffee in the brewing chamber, an outlet opening for disposal of a substance from the brewing chamber. The brewer also includes a piston for tamping the ground coffee that, when looking from top to bottom in the brewing chamber, includes a closed frontal pressing surface that is straight at least in its upper quarter and gradually inclines forward upon approaching the bottom of the brewing chamber, allowing the pressing action of the piston on the ground coffee to be initiated sooner and more severe near to the bottom than near to the top of the brewing chamber.

### CROSS-REFERENCE TO RELATED APPLICATIONS

This application is a continuation of International Application No. PCT/NL2024/050425, entitled “BREWER FOR A COFFEE MACHINE”, filed Jul. 30, 2024, which claims priority to and the benefit of Netherlands Patent Application No. 2035573, entitled “BREWER FOR A COFFEE MACHINE”, filed Aug. 9, 2023, and the specifications and claims thereof are incorporated herein by reference.

### BACKGROUND OF THE INVENTION

### Field of the Invention

The invention relates to a brewer for a coffee machine, and more particularly, a brewer comprising a horizontal brewing chamber with an inlet opening for receiving ground coffee in the brewing chamber, an outlet opening for disposal from a substance from the brewing chamber, and at least one piston for tamping the ground coffee.

### Background

EP 2 690 991 B1 discloses an example of a brewer.

EP 3 248 517 A1 also discloses a brewer for preparing coffee, with a tubular horizontal housing in which at least a first piston is arranged so that it can move axially in order to form a brewing chamber for receiving ground coffee and for brewing the coffee drink, with an adjustment device, which is designed to variably change the dimensions of the brewing chamber to accommodate for different desired coffee strength, different ways of preparing the coffee, or desired amounts of coffee.

Another type horizontal brewer is known from EP 1 121 882 A2, which discloses an automatic espresso coffee dispensing unit comprising hot water delivery means and, for containing coffee powder or a capsule, a compartment to be moved into sealed relationship against said delivery means, said compartment being in the form of a cylindrical jacket rigid with a movable hollow body which is mounted on a fixed hollow body to create a variable volume chamber connected via a two- or three-way valve to a pressurized water source and to a discharge. The piston that pressurizes the coffee powder has a concave curved frontal pressing surface.

Yet another example of a horizontal brewer is known from WO2022/249118, wherein the brewing chamber is provided with a front piston which has a frontal surface configured for evenly distributing hot water.

A brewer with a horizontal brewing chamber provides advantages and disadvantages.

When the brewing chamber is horizontal, the coffee falls to the bottom during dosing. This causes the formation of a coffee lump at the bottom of the brewing chamber. When the brewing chamber closes and the coffee is compressed into a pill, the coffee will tend to have an uneven distribution. The largest amount of coffee remains in the lower part of the pill and only a small amount of coffee will be in the top half of the pill. The result of this is that the density of the lower half of the coffee pill is very high while the upper part consists of fairly loose coffee. When making coffee with this coffee pill, the brewing water will find a path of having the lowest resistance and flow therefore predominantly through the top half of the pill, a process called channeling. The result is a sub-optimal preparation. An additional problem is that the composition of the pill is highly dependent on chance. One time the substance of the pill is slightly better than another time. Channeling is also very unpredictable. The resulting flow times of the brewing water, i.e. the extraction times therefore vary widely and so does the quality of the coffee.

Note that this application refers to a number of references, including those discussed above. Discussion of such references is given for more complete background and is not to be construed as an admission that such publications are prior art for purposes of determining patentability of the present invention.

### BRIEF SUMMARY OF THE INVENTION

It is an object of the invention to avoid the above problems and provide further benefits as will become apparent from the following disclosure.

Embodiments of the present invention are directed to a brewer comprising the features recited by one or more of the appended claims.

Preferably, the brewer has the feature that, when looking from top to bottom in the horizontal brewing chamber, the at least one piston comprises a closed frontal pressing surface that gradually inclines forward upon approaching the bottom of the brewing chamber, such that the pressing action of the piston on the ground coffee is initiated sooner and more severe near to the bottom than near to the top of the brewing chamber, wherein further the brewer is configured such that before receiving the ground coffee, the piston is moved to an end-position so as to provide the brewing chamber with a predefined space in which the ground coffee is received that depends on the amount of ground coffee, and that the horizontal brewing chamber of the brewer comprises a bottom on which the ground coffee rests, which brewing chamber together with the at least one piston is configured to be repeatedly moved back-and-forth with reference to said stationary inlet opening for receiving ground coffee so as to promote an evenly distribution of said ground coffee resting on the bottom of the brewing chamber prior to tamping of the ground coffee with the at least one piston.

Accordingly, the piston comprises a bulge/chamfer which makes the brewing chamber slightly smaller at the bottom than at the top. When the brewing chamber is thus filled with coffee, the coffee will have a higher density at the bottom, but because there is less coffee here because of the bulge, the flow properties of the entire pill are improved so that they can be the same over the entire height of the coffee pill. The pill that is pressed with the bulged piston has improved homogeneity, resulting in better extraction and greater repeatability/consistency.

The predefined space in which the ground coffee is received is determined so as to exactly match a required volume for receiving the amount of ground coffee of a particular grain size. By thus giving the brewing chamber a format that is completely filled by coffee, the homogeneity of the formed coffee pill is considerably improved and the preparation is of better quality and greater repeatability.

Particularly when larger doses of coffee (for example above 9 grams) are required wherein the ejector/piston moves deeper into the brewing chamber to increase the brewing chamber volume, the entire brewing chamber together with the at least one piston can be repeatedly moved back-and-forth with reference to said stationary inlet opening to push the ground coffee to the rear of the brewing chamber. With this repeated motion it is possible to continuously dose large quantities of coffee into the brewing chamber and to greatly improve the filling/homogeneity. It is remarked that the repeated moving back-and-forth of the brewing chamber with the at least one piston may occur many times, such as 10 times or more and at a high rate.

It may be beneficial that the closed frontal pressing surface of the piston is straight at least in its upper quarter.

It is desirable to adjust the size of the brewing chamber (and thus the filling space) to the amount of coffee for the chosen drink. For example, with a small drink requiring only 30% of the brewing chamber volume, the chamber volume can be set to the correct size prior to dosing ground coffee, so that the entire chamber will be filled exactly.

The size of the chamber is adjusted by placing the piston in an intermediate position between an ejection position and the tamping position. Usually a precise control is present on the brewer, allowing that the brewing chamber volume can be set in very fine steps, so that the ideal filling volume can always be achieved.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1a, 1b and 1c are series of illustrations of schematic cross-sectional views of a brewer for a coffee machine in a filling position (FIG. 1a), a preparation position (FIG. 1b) and an ejection position (FIG. 1c), according to an embodiment of the present invention;

FIG. 2 is a series of illustrations of schematic cross-sectional views of a brewer for a coffee machine in different filling positions of the piston to accommodate different quantities of ground coffee, according to an embodiment of the present invention;

FIG. 3 is series of illustrations of schematic cross-sectional views showing the effect achieved when the size of the brewing chamber is reduced by repositioning of the piston, according to an embodiment of the present invention;

FIG. 4 is series of illustrations of schematic cross-sectional views showing the effect of varying the position of the bottom on which the ground coffee rests so as to accommodate and promote a more uniform distribution of a medium amount of ground coffee received in the brewing chamber, according to an embodiment of the present invention; and

FIG. 5 is series of illustrations of schematic cross-sectional views showing the effect of repeatedly varying the position of the bottom on which the ground coffee rests so as to accommodate and promote a more uniform distribution of a maximum amount of ground coffee received in the brewing chamber according to an embodiment of the present invention.

### DETAILED DESCRIPTION OF THE INVENTION

Whenever in the figures the same reference numerals are applied, these numerals refer to the same parts.

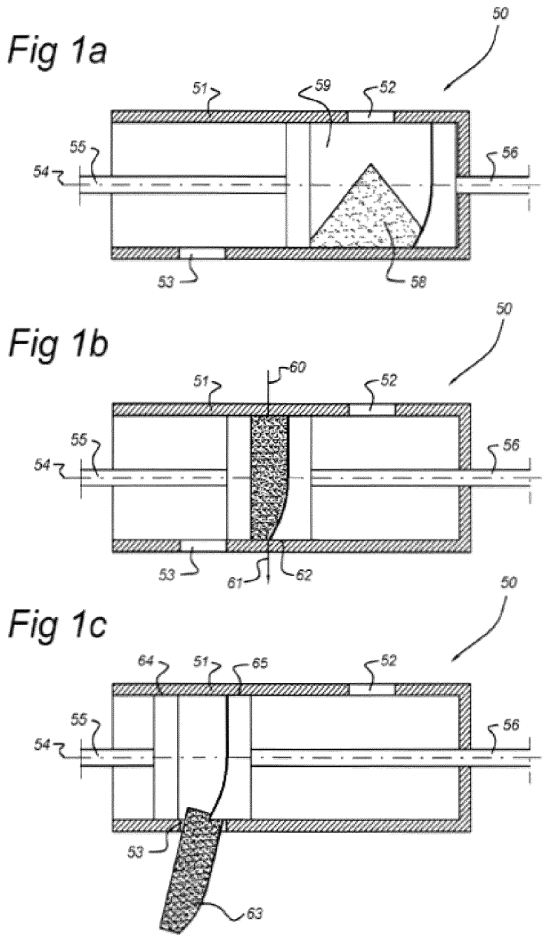

FIG. 1a shows a horizontal brewer in a filling position according to an embodiment of the present invention. Brewer 50 comprises housing 51 with stationary filling opening 52, ejection opening 53 and a pair of compression elements in the form of pistons 55, 56 displaceable along longitudinal axis 54. It is also possible to provide brewer 50 with single piston 56, and to provide ejection opening 53 straight below filling opening 52, with additional features to secure ejection opening 53 in a closed position during tamping with piston 56 and during brewing.

In the shown embodiment with two pistons, pistons 55, 56 are displaced away from each other when brewer 50 is in the filling position, and ground coffee 58 can be placed via filling opening 52 in brewing chamber 59 between pistons 55, 56.

In order to tamp ground coffee 58, pistons 55, 56 are displaced toward each other so that ground coffee 58 gets compressed into a tablet or pill when it eventually arrives in the preparation position as shown in FIG. 1b.

It is clearly shown in the embodiment depicted in the figures that when looking from top to bottom in the horizontal brewing chamber 59, at least one piston 56 is provided with a closed frontal pressing surface that gradually inclines forward upon approaching the bottom of brewing chamber 59, such that the pressing action of the piston on the ground coffee is initiated sooner and more severe near to the bottom than near to the top of brewing chamber 59. In the shown embodiment a preferable feature is included, to note that piston 56 is straight at least in its upper quarter. Clearly the chamfer of piston 56 according to the invention, causes reduced dimensions of brewing chamber 59 at the bottom in comparison with the dimensions at the top of brewing chamber 59. It will be clear to the skilled person that the shown embodiment is merely an example, and that other shapes and forms of piston 56 are feasible within the scope of the invention. The chamfer may for instance already start at the top edge of piston 56.

In the preparation position shown in FIG. 1b, hot water is squeezed through brewing chamber 59 and the compressed tablet or coffee pill contained therein via supply 60 and discharge 61 indicated by arrows.

Finally FIG. 1c shows that both pistons 55, 56 move jointly to the ejection position, wherein the pistons move away from each other and processed tablet 63 is removed under the influence of gravity via ejection opening 53.

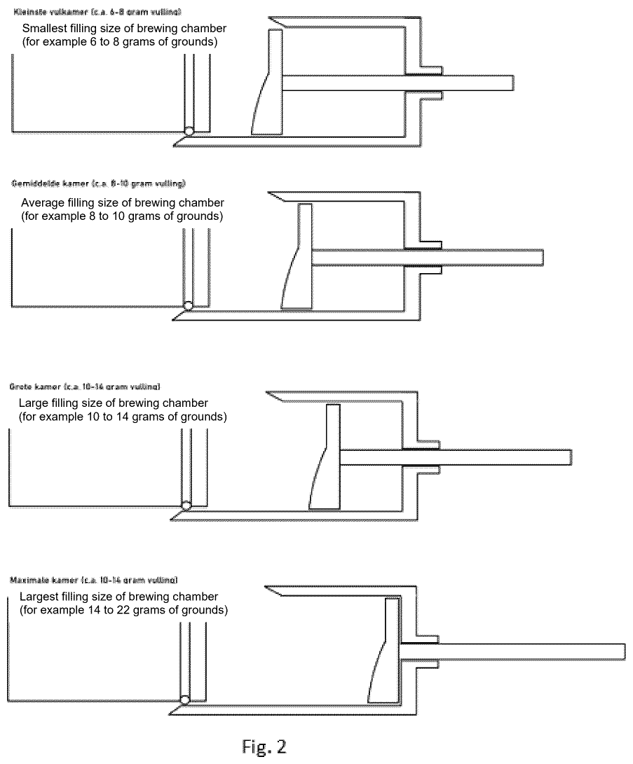

According to the invention, before tamping of ground coffee 58 as shown in FIG. 1b, piston 56 is moved to an end-position so as to provide brewing chamber 59 with a predefined volume of the space in which ground coffee 58 is received that depends on the amount of ground coffee 58. The said predefined space is thus determined so as to exactly match a required volume for receiving the amount of ground coffee 58 of a particular grain size. This is more clearly depicted in FIG. 2 which shows several positions of the (in this case single) piston in the brewing chamber, which from top to bottom accommodate a smallest brewing chamber capable to receive about 6 to about 8 grams of ground coffee, a medium-size brewing chamber capable to receive about 8 to about 10 grams of ground coffee, a large and a maximum brewing chamber each capable to receive about 10 to about 14 grams of ground coffee.

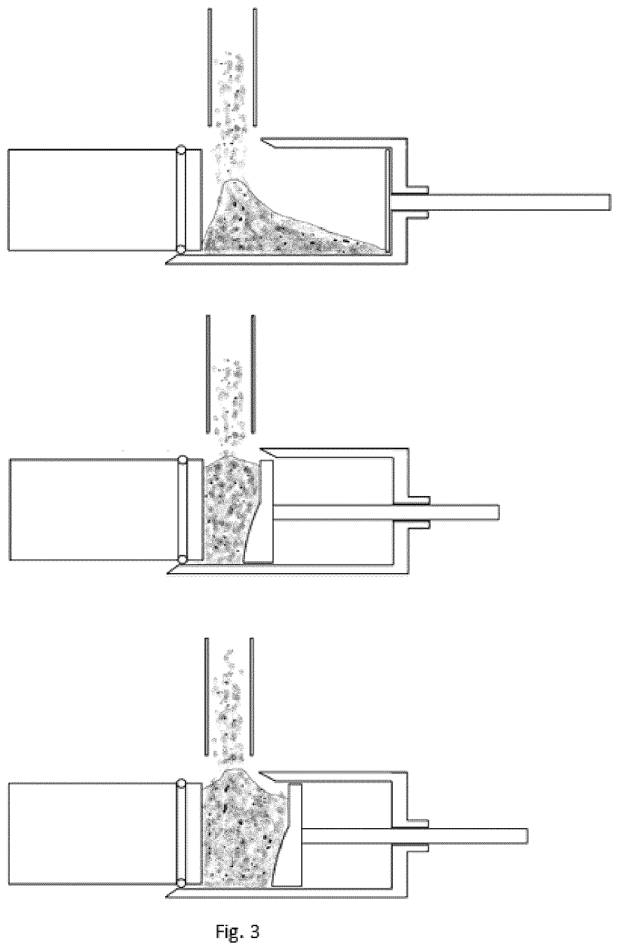

FIG. 3 shows the effect of reducing the size of the brewing chamber which is loaded with a certain amount of ground coffee. The top figure in FIG. 3 shows the prior art situation when the brewing chamber is always maintained at the same volume irrespective of the amount of ground coffee it has received. The middle figure shows that the piston has moved to reduce the volume of the brewing chamber and accordingly tamp a moderate amount of about 6 to about 8 grams of ground coffee received in the brewing chamber. The piston has then moved to the largest extent to provide the receiving chamber with a size that accommodates this small amount of ground coffee. The bottom figure differentiates from the middle figure in that the amount of ground coffee received in the brewing chamber is increased to receive about 8 to about 10 grams of ground coffee, and that the brewing chamber is correspondingly enlarged to accommodate this larger amount of ground coffee.

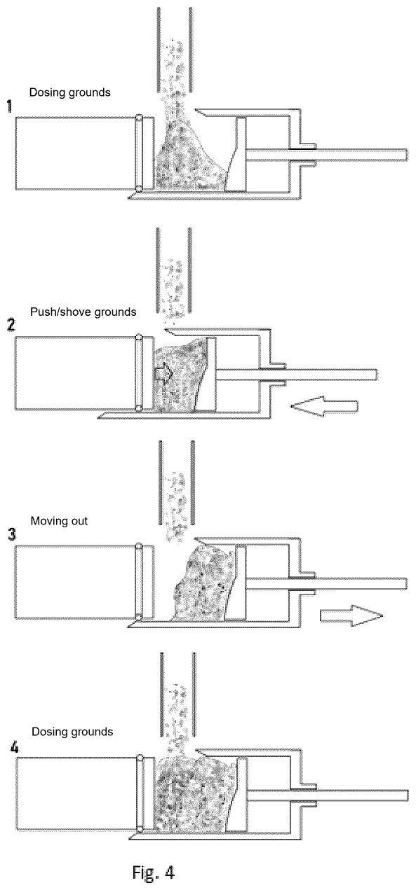

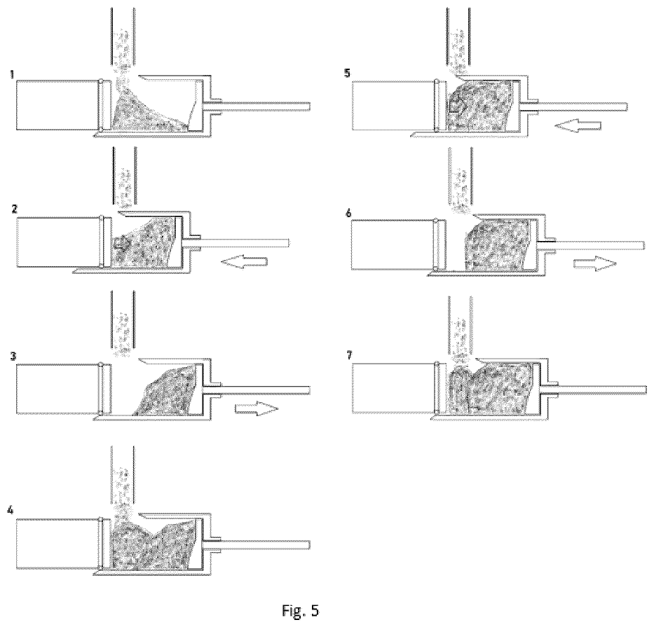

For processing larger quantities of ground coffee 58 the horizontal brewing chamber of the brewer 50 is equipped with a bottom on which ground coffee 58 rests, and which is repeatably movable back-and-forth so as to promote an evenly distribution of the ground coffee resting on said bottom. This is depicted in FIG. 4 and FIG. 5.

FIG. 4 shows, from top to bottom, first the filling of the brewing chamber with a certain amount of ground coffee, and immediately in the figure thereunder a repositioning of the piston together with the bottom of the brewing chamber so as to tamp the ground coffee together, followed in the figure thereunder by a second back motion of both the piston and the bottom of the brewing chamber so as to make room for an additional load of ground coffee as shown at the bottom of FIG. 4. The operation of FIG. 4 applies to filling the receiving chamber with a medium amount of ground coffee.

FIG. 5 differentiates from FIG. 4 in that the amount of ground coffee to be eventually received in the brewing chamber is a maximum amount. This means that after reaching the position of the piston and the bottom of the brewing chamber to make room for an additional load of ground coffee as shown at the bottom of FIG. 4, which corresponds to what is shown at the left bottom figure in FIG. 5, there may be additional ‘shovel’ operations by the piston and subsequent backward motion of the piston concertedly with the bottom of the brewing chamber to make room for a second and further additional loads of ground coffee as depicted in the right bottom figure in FIG. 5. This operation may indeed be repeated frequently for receiving sufficient additional loads of ground coffee. The repeated moving back-and-forth of the brewing chamber with the at least one piston may therefore occur many times, such as 10 times or more and will be carried out at a high rate. The operation is completed by tamping of the ground coffee with the at least one piston.

Embodiments of the present invention can include every combination of features that are disclosed herein independently from each other. Although the invention has been discussed in the foregoing with reference to an exemplary embodiment of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Note that in the specification and claims, “about” or “approximately” means within twenty percent (20%) of the numerical amount cited. The terms, “a”, “an”, “the”, and “said” mean “one or more” unless context explicitly dictates otherwise.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1. A brewer for a coffee machine, the brewer comprising:
a horizontal brewing chamber comprising a stationary inlet opening for receiving ground coffee in the brewing chamber, the horizontal brewing chamber comprising a bottom on which the ground coffee rests;
an outlet opening for disposal of a substance from the brewing chamber;
at least one piston for tamping the ground coffee;
wherein the brewer is configured such that before receiving the ground coffee, the piston is capable of being moved to an end-position so as to provide the brewing chamber with a predefined space in which the ground coffee is received that depends on the amount of ground coffee,
wherein the brewing chamber together with the at least one piston is capable of being repeatedly moved back-and-forth with reference to said stationary inlet opening prior to tamping of the ground coffee with the at least one piston so as to promote an evenly distribution of said ground coffee resting on the bottom of the brewing chamber, and
wherein, when looking from top to bottom in the horizontal brewing chamber, the at least one piston comprises a closed frontal pressing surface that gradually inclines forward upon approaching the bottom of the brewing chamber, such that the pressing action of the piston on the ground coffee is initiated sooner and more severe near to the bottom than near to the top of the brewing chamber.

2. The brewer according to claim 1, wherein the at least one piston comprises a closed frontal pressing surface that is straight at least in its upper quarter.

3. The brewer according to claim 1, wherein the brewer is configured such that the predefined space is determined so as to exactly match a required volume for receiving the amount of ground coffee of a particular grain size.

4. Use of a brewer for a coffee machine, the brewer comprising:
a horizontal brewing chamber and a stationary inlet opening for receiving ground coffee (58) in the brewing chamber;
an outlet opening for disposal of a substance from the brewing chamber;
at least one piston for tamping the ground coffee;
wherein the brewer is configured such that before receiving the ground coffee, the piston is moved to an end-position so as to provide the brewing chamber with a predefined space in which the ground coffee is received that depends on the amount of ground coffee, and that the horizontal brewing chamber of the brewer comprises a bottom on which the ground coffee rests,
wherein the brewing chamber together with the at least one piston is repeatedly moved back-and-forth with reference to said stationary inlet opening prior to tamping of the ground coffee with the at least one piston so as to promote an evenly distribution of said ground coffee resting on the bottom of the brewing chamber, and
wherein when looking from top to bottom in the horizontal brewing chamber the at least one piston is provided with a closed frontal pressing surface that gradually inclines forward upon approaching the bottom of the brewing chamber, such that the pressing action of the piston on the ground coffee is initiated sooner and more severe near to the bottom than near to the top of the brewing chamber.

5. Use of a brewer according to claim 4, wherein the at least one piston comprises a closed frontal pressing surface that is straight at least in its upper quarter.

6. Use of a brewer according to claim 4, wherein the brewer is configured such that the predefined space is determined so as to exactly match a required volume for receiving the amount of ground coffee of a particular grain size.
